(19) United States
(12) Patent Application Publication
(10) Pub. No.: US 2021/0316539 A1
(43) Pub. Date: Oct. 14, 2021

(54) LAMINATES AND ARTICLES INCORPORATING LAMINATES

(71) Applicants: Dow Global Technologies LLC, Midland, MI (US); Rohm and Haas Company, Collegeville, PA (US)

(72) Inventors: Gang WANG, Shanghai (CN); Gaobing CHEN, Shanghai (CN); Jingyi XU, Shanghai (CN); Xiaobing YUN, Shanghai (CN); Jianping PAN, Shanghai (CN)

(21) Appl. No.: 17/265,543

(22) PCT Filed: Nov. 1, 2018
(86) PCT No.: PCT/CN2018/113360

§ 371 Date: Feb. 3, 2021

(51) Int. Cl. B32B 27/08; B32B 7/12; B32B 27/20; B32B 27/30

(52) U.S. Cl. CPC B32B 27/08; B32B 7/12; B32B 27/20; B32B 27/30; B32B 2307/518; B32B 2439/70; B32B 2307/7244; B32B 2307/732; B32B 2307/75; B32B 2307/7246; B32B 2307/72

(57) ABSTRACT

It provides laminates and articles formed from such laminates. In one aspect, a laminate comprises (a) a biaxially oriented polyethylene (BOPE) film comprising a polyethylene composition, wherein the polyethylene composition has a density of 0.910 to 0.940 g/cm³, an MW_{HDF>95} greater than 135 kg/mol and an I_{HDF >95} greater than 42 kg/mol, wherein the BOPE film comprises at least 50 weight percent of the polyethylene composition based on the weight of the BOPE film; (b) a barrier adhesive layer comprising polyurethane; and (c) a polyethylene film, wherein the barrier adhesive layer adheres the BOPE film to the polyethylene film and wherein the laminate has an oxygen gas transmission rate of 700 cc/[m²-day] or less when measured according to ASTM D3985-05.

### FIELD

The present invention relates to laminates and to articles incorporating laminates.

### INTRODUCTION

Some packages such as food packages are designed to protect the contents from the external environment and to facilitate a longer shelf. Such packages are often constructed using barrier films with low oxygen transmission rates (OTR) and water vapor transmission rates (WVTR). However, in balancing the barrier properties, consideration is also given to package integrity to, for example, avoid leakage.

To provide barrier properties to multilayer structures such as films and laminates, a variety of different approaches are taken in the industry including, for example, incorporating polymeric barrier layers through coextrusion, providing a metal layer on a film substrate through vacuum metallization, coating barrier polymers on film surfaces, laminating films with aluminum foil layers, and other approaches. In addition to having good barrier properties after manufacture, it is also important for multilayer structures and packages made from such structures to have good barrier properties following the physical stresses associated with transportation and end-use.

There remains a need for new approaches to multilayer structures, such as laminates, that provide barrier properties, desirable package integrity, and the ability to maintain barrier properties following physical stresses similar to those associated with assembly, transportation, and end-use.

### SUMMARY

The present invention provides laminates that can provide a good synergy of barrier properties and mechanical properties, as well as maintain barrier properties following flex treatments to simulate stresses in transportation and use. For example, in some embodiments, laminates of the present invention can provide a good barrier to oxygen and/or water vapor both before and after flex treatment while also exhibiting desirable mechanical properties.

In one aspect, the present invention provides a laminate that comprises (a) a biaxially oriented polyethylene (BOPE) film comprising a polyethylene composition, wherein the polyethylene composition has a density of 0.910 to 0.940 g/cm³, an MW_{HDF>95} greater than 135 kg/mol and an I_{HDF>95} greater than 42 kg/mol, wherein the BOPE film comprises at least 50 weight percent of the polyethylene composition based on the weight of the BOPE film; (b) a barrier adhesive layer comprising polyurethane; and (c) a polyethylene film, wherein the barrier adhesive layer adheres the BOPE film to the polyethylene film and wherein the laminate has an oxygen gas transmission rate of 700 cd[m²-day] or less when measured according to ASTM D3985-05.

In another aspect, the present invention relates to an article, such as a food package, comprising any of the laminates disclosed herein.

These and other embodiments are described in more detail in the Detailed Description.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount (>50 mol %) of units derived from ethylene monomer, and the remaining units derived from one or more α-olefins. Typical α-olefins used in forming ethylene/α-olefin interpolymers are C₃-C₁₀ alkenes.

The term, “ethylene/α-olefin copolymer,” as used herein, refers to a copolymer that comprises, in polymerized form, a majority amount (>50 mol %) of ethylene monomer, and an α-olefin, as the only two monomer types.

The term “α-olefin”, as used herein, refers to an alkene having a double bond at the primary or alpha (a) position.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” or “ethylene-based polymer” shall mean polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. Nos. 3,914,342 or 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm³ and up to about 0.970 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, chrome catalysts, or single-site catalysts including, but not limited to, bis-metallocene catalysts and constrained geometry catalysts.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

“Polypropylene” means polymers comprising greater than 50% by weight of units which have been derived from propylene monomer. This includes polypropylene homopolymers or copolymers (meaning units derived from two or more comonomers). Common forms of polypropylene known in the art include homopolymer polypropylene (hPP), random copolymer polypropylene (rcPP), impact copolymer polypropylene (hPP+at least one elastomeric impact modifier) (ICPP) or high impact polypropylene (HIPP), high melt strength polypropylene (HMS-PP), isotactic polypropylene (iPP), syndiotactic polypropylene (sPP), and combinations thereof.

All references to “MW_{HDP>95}” and “I_{HDF>95}” herein refer to these properties as measured according to Crystallization Elution Fractionation (CEF) as described in the TEST METHODS section below.

In one aspect, the present invention provides a laminate that comprises (a) a biaxially oriented polyethylene (BOPE) film comprising a polyethylene composition, wherein the polyethylene composition has a density of 0.910 to 0.940 g/cm³, an MW_{HDF>95} greater than 135 kg/mol and an I_{HDF>95} greater than 42 kg/mol, wherein the BOPE film comprises at least 50 weight percent of the polyethylene composition based on the weight of the BOPE film; (b) a barrier adhesive layer comprising polyurethane; and (c) a polyethylene film, wherein the barrier adhesive layer adheres the BOPE film to the polyethylene film and wherein the laminate has an oxygen gas transmission rate of 700 cc/[m²-day] or less when measured according to ASTM D3985-05. In some embodiments, the BOPE film is oriented in the machine direction at a draw ratio from 2:1 to 6:1 and in the cross direction at a draw ratio from 2:1 to 9:1. The BOPE film, some embodiments, has an overall draw ratio (draw ratio in machine direction X draw ratio in cross direction) of 8 to 54. In some embodiments, the ratio of the draw ratio in the machine direction to the draw ratio in the cross direction is from 1:1 to 1:2.5.

In some embodiments, the BOPE film is either reverse printed or surface printed. The BOPE film can be reverse printed or surface printed using techniques known to those of ordinary skill in the art.

In some embodiments, the polyurethane in the barrier adhesive layer comprises an isocyanate component comprising a single species of polyisocyanate, and an isocyanate-reactive component comprising a hydroxyl-terminated polyester incorporated as substantially-miscible solids in a carrier solvent, the polyester formed from a single species of a linear aliphatic diol having terminal hydroxyl groups and from 2 to 10 carbon atoms, and a linear dicarboxylic acid, the polyester having a number average molecular weight from 300 to 5,000 and being solid at 25° C., and having a melting point of 80° C. or below.

The BOPE film is a multilayer film in some embodiments and a monolayer film in other embodiments. In some embodiments, the BOPE film further comprises at least one of a high density polyethylene, a low density polyethylene, a linear low density polyethylene, a polyethylene plastomer, a polyethylene elastomer, an ethylene vinyl acetate copolymer, an ethylene ethyl acrylate copolymer, any other polymer comprising at least 50% ethylene monomer, or a combination thereof.

The polyethylene film comprises at least 50 weight percent polyethylene based on the total weight of the polyethylene film, in some embodiments. In some embodiments, the polyethylene film comprises at least one of a high density polyethylene, a low density polyethylene, a linear low density polyethylene, a polyethylene plastomer, a polyethylene elastomer, an ethylene vinyl acetate copolymer, an ethylene ethyl acrylate copolymer, any other polymer comprising at least 50% ethylene monomer, or a combination thereof. The thickness of the BOPE film is from 10 to 70 microns in some embodiments, or from 15 to 40 microns in some embodiments. The thickness of the polyethylene film is from 20 to 200 microns in some embodiments, or from 40 to 150 microns in some embodiments. In some embodiments, the polyethylene film comprises polyethylene having a melt index (I₂) from 0.5 to 6 g/10 minutes and a density from 0.900 to 0.960 g/cm³ and has a thickness from 20 to 200 microns. The thickness ratio of the BOPE film to the polyethylene film is from 0.1 to 1 in some embodiments, or from 0.2 to 0.8 in some embodiments.

A laminate of the present invention can comprise a combination of two or more embodiments as described herein.

Embodiments of the present invention also relate to articles such as packages. In some embodiments, an article of the present invention can include any of the inventive laminates disclosed herein. An article of the present invention can comprise a combination of two or more embodiments as described herein.

### Biaxially Oriented Polyethylene Film

Laminates of the present invention comprise a biaxially oriented polyethylene film. The lamination of the biaxially oriented polyethylene film to the polyethylene film with the barrier adhesive layer (as described further herein), in some embodiments, advantageously provides barrier to oxygen and/or water vapor both before and after flex treatment while also exhibiting desirable mechanical properties.

The biaxially oriented polyethylene film comprises a polyethylene composition that has a density of 0.910 to 0.940 g/cm³, an MW_{HDF>95} greater than 135 kg/mol, and I_{HDF>95} greater than 42 kg/mol. In some embodiments, the polyethylene composition comprises two or more linear low density polyethylenes (LLDPE). The LLDPEs used in the polyethylene composition can include Ziegler-Natta catalyzed linear low density polyethylene, single site catalyzed (including metallocene) linear low density polyethylene, and medium density polyethylene (MDPE) so long as the MDPE has a density no greater than 0.940 g/cm³, as well as combinations of two or more of the foregoing.

The polyethylene composition comprises from 20 to 50 wt % of a first linear low density polyethylene. All individual values and subranges from 20 to 50 percent by weight (wt %) are included herein and disclosed herein; for example the amount of the first linear low density polyethylene can be from a lower limit of 20, 30, or 40 wt % to an upper limit of 25, 35, 45, or 50 wt %. For example, the amount of the first linear low density polyethylene can be from 20 to 50 wt %, or in the alternative, from 20 to 35 wt %, or in the alternative, from 35 to 50 wt %, or in the alternative from 25 to 45 wt %.

The first linear low density polyethylene has a density greater than or equal to 0.925 g/cm³ in some embodiments. All individual values and subranges greater than or equal to 0.925 g/cm³ are included herein and disclosed herein; for example, the density of the first linear low density polyethylene can be from a lower limit of 0.925, 0.928, 0.931 or 0.934 g/cm³. In some aspects, the first linear low density polyethylene has a density less than or equal to 0.980 g/cm³. All individual values and subranges of less than 0.980 g/cm³ are included herein and disclosed herein; for example, the first linear low density polyethylene can have a density from an upper limit of 0.975, 0.970, 0.960, 0.950, or 0.940 g/cm³. In some embodiments, the first linear low density polyethylene has a density from 0.925 to 0.940 g/cm³.

The first linear low density polyethylene has a melt index (I₂) less than or equal to 2 g/10 minutes. All individual values and subranges from 2 g/10 minutes are included herein and disclosed herein. For example, the first linear low density polyethylene can have an 12 from an upper limit of 2, 1.9, 1.8, 1.7, 1.6 or 1.5 g/10 minutes. In a particular aspect, the first linear low density polyethylene has an 12 with a lower limit of 0.01 g/10 minutes. All individual values and subranges from 0.01 g/10 minutes are included herein and disclosed herein. For example, the first linear low density polyethylene can have an 12 greater than or equal to 0.01, 0.05, 0.1, 0.15 g/10 minutes.

The polyethylene composition comprises from 80 to 50 wt % of a second linear low density polyethylene. All individual values and subranges from 80 to 50 wt % are included herein and disclosed herein; for example, the amount of the second linear low density polyethylene can be from a lower limit of 50, 60 or 70 wt % to an upper limit of 55, 65, 75 or 80 wt %. For example, the amount of the second linear low density polyethylene can be from 80 to 50 wt %, or in the alternative, from 80 to 60 wt %, or in the alternative, from 70 to 50 wt %, or in the alternative, from 75 to 60 wt %.

The second linear low density polyethylene has a density lower than or equal to 0.925 g/cm³. All individual values and subranges lower than or equal to 0.925 g/cm³ are included herein and disclosed herein; for example, the density of the second linear low density polyethylene can have an upper limit of 0.925, 0.921, 0.918, 0.915, 0.911, or 0.905 g/cm³. In a particular aspect, the density of the second linear low density polyethylene can have a lower limit of 0.865 g/cm³. All individual values and subranges equal to or greater than 0.865 g/cm³ are included herein and disclosed herein; for example, the density of the second linear low density polyethylene can have a lower limit of 0.865, 0.868, 0.872, or 0.875 g/cm³.

The second linear low density polyethylene has a melt index (I₂) greater than or equal to 2 g/10 minutes. All individual values and subranges from 2 g/10 minutes are included herein and disclosed herein; for example, the 12 of the second linear low density polyethylene can have a lower limit of 2, 2.5, 5, 7.5 or 10 g/10 minutes. In a particular aspect, the second linear low density polyethylene has an 12 of less than or equal to 1000 g/10 minutes.

In some embodiments, the polyethylene composition (comprising the first linear low density polyethylene and the second linear low density polyethylene) used in the outer layer of the biaxially oriented polyethylene film has a density of 0.910 to 0.940 g/cm³. All individual values and subranges from 0.910 to 0.940 g/cm³ are included herein and disclosed herein; for example, the density of the polyethylene composition can be from a lower limit of 0.910, 0.915, 0.920, 0.922, 0.925, 0.928, or 0.930 g/cm³ to an upper limit of 0.940, 0.935, 0.930, 0.925, 0.920 or 0.915 g/cm³. In some aspects of the invention, the polyethylene composition has a density from 0.910 to 0.930 g/cm³. In some aspects of the invention, the polyethylene composition has a density from 0.915 to 0.930 g/cm³.

In some embodiments, the polyethylene composition in the biaxially oriented polyethylene film has a melt index (I₂) of 30 g/10 minutes or less. All individual values and subranges up to 30 g/10 minutes are included herein and disclosed herein. For example, the polyethylene composition can have a melt index from a lower limit of 0.1, 0.2, 0.25, 0.5, 0.75, 1, 2, 4, 5, 10, 15, 17, 20, 22, or 25 g/10 minutes to an upper limit of 2, 4, 5, 10, 15, 18, 20, 23, 25, 27, or 30 g/10 minutes. The polyethylene composition, in some embodiments, has a melt index (I₂) of 2 to 15 g/10 minutes.

The biaxially oriented polyethylene film comprises a significant amount of the polyethylene composition. In some embodiments, the biaxially oriented polyethylene film comprises at least 50 weight percent of the polyethylene composition, based on the weight of the BOPE film. The BOPE film comprises at least 70 weight percent of the polyethylene composition, based on the weight of the BOPE film, in some embodiments. In some embodiments, the BOPE film comprises at least 90 weight percent of the polyethylene composition, based on the weight of the BOPE film. In some embodiments, the BOPE film comprises at least 95 weight percent of the polyethylene composition, based on the weight of the BOPE film. The BOPE film comprises up to 100 weight percent of the polyethylene composition, based on the weight of the BOPE film in some embodiments.

In embodiments where the linear low density polyethylenes in the polyethylene composition are not the only polymers in the biaxially oriented polyethylene film, BOPE film comprises at least 50 weight percent of the first polyethylene composition, based on the weight of the BOPE film, and the film can further comprise other polymers that have, in polymerized form, a majority amount of ethylene (>50 mol %), and optionally may comprise one or more comonomers. Such polymers include high density polyethylene (HDPE), low density polyethylene (LDPE), ultra low density polyethylene (ULDPE), polyethylene plastomer, polyethylene elastomer, ethylene vinyl acetate copolymer, ethylene ethyl acrylate copolymer, any other polymer comprising at least 50 mol % ethylene monomer, and combinations thereof. Persons of skill in the art can select suitable commercially available ethylene-based polymer for use in the BOPE film based on the teachings herein.

The biaxially oriented polyethylene film, and in particular an outer layer when the BOPE film is a multilayer film, may contain one or more additives as is generally known in the art. Such additives include antioxidants, such as IRGANOX 1010 and IRGAFOS 168 (commercially available from BASF), ultraviolet light absorbers, antistatic agents, pigments, dyes, nucleating agents, fillers, slip agents, fire retardants, plasticizers, processing aids, lubricants, stabilizers, smoke inhibitors, viscosity control agents, surface modification agents, and anti-blocking agents. The BOPE film (when a monolayer film) or the outer layer of a multilayer BOPE film may advantageously, for example, comprise less than 10 percent by the combined weight of one or more additives, based on the weight of the outer layer in some embodiments, and less than 5 percent by weight in other embodiments.

In some embodiments, the biaxially oriented polyethylene film is a monolayer film.

In some embodiments, the biaxially oriented polyethylene film is a multilayer film. For example, a multilayer film can further comprise a variety of layers typically included in multilayer films depending on the application including, for example, sealant layers, barrier layers, tie layers, other polyethylene layers, etc. In some embodiments, a multilayer BOPE film does not include a barrier layer comprising a polar polymer such as polyamide or ethylene vinyl alcohol. In some embodiments, a multilayer BOPE film may not need to include a sealant layer because, for example, the polyethylene film that is laminated to the BOPE film may include a sealant layer.

In embodiments where the BOPE is a multilayer film, the other layers can comprise any number of other polymers or polymer blends. In some such embodiments, the polyethylene composition as described above comprises at least 50 weight percent of the BOPE film based on the total weight (including all layers) of the BOPE film.

Depending on the composition of the additional layer and the multilayer film, in some embodiments, the additional layer can be coextruded with other layers in the film.

It should be understood that any of the foregoing layers in a multilayer BOPE film can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

Such polyethylene films (whether monolayer or multilayer), prior to biaxial orientation, can have a variety of thicknesses depending, for example, on the number of layers, the intended use of the film, and other factors. Such polyethylene films, in some embodiments, have a thickness prior to biaxial orientation of 320 to 3200 microns (typically, 640-1920 microns).

Prior to biaxial orientation, the polyethylene films can be formed using techniques known to those of skill in the art based on the teachings herein. For example, the films can be prepared as blown films (e.g., water quenched blown films) or cast films. For example, in the case of multilayer polyethylene films, for those layers that can be coextruded, such layers can be coextruded as blown films or cast films using techniques known to those of skill in the art based on the teachings herein.

In some embodiments, the polyethylene film is biaxially oriented using a tenter frame sequential biaxial orientation process. Such techniques are generally known to those of skill in the art. In other embodiments, the polyethylene film can be biaxially oriented using other techniques known to those of skill in the art based on the teachings herein, such as double bubble orientation processes. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for annealing.

Without wishing to be bound by any particular theory, it is believed that the biaxial orientation of the polyethylene film specified herein provides increased modulus and high ultimate strength which facilitates deposition of the metal layer (at high speeds, in some embodiments) and provides an improved glossy appearance.

In some embodiments, the polyethylene film can be oriented in the machine direction at a draw ratio of 2:1 to 6:1, or in the alternative, at a draw ratio of 3:1 to 5:1. The polyethylene film, in some embodiments, can be oriented in the cross direction at a draw ratio of 2:1 to 9:1, or in the alternative, at a draw ratio of 3:1 to 8:1. In some embodiments, the polyethylene film is oriented in the machine direction at a draw ratio of 2:1 to 6:1 and in the cross direction at a draw ratio of 2:1 to 9:1. The polyethylene film, in some embodiments, is oriented in the machine direction at a draw ratio of 3:1 to 5:1 and in the cross direction at a draw ratio of 3:1 to 8:1.

In some embodiments, the ratio of the draw ratio in the machine direction to the draw ratio in the cross direction is from 1:1 to 1:2.5. In some embodiments, the ratio of the draw ratio in the machine direction to the draw ratio in the cross direction is from 1:1.5 to 1:2.0.

In some embodiments, the biaxially oriented polyethylene film has an overall draw ratio (draw ratio in machine direction X draw ratio in cross direction) of 8 to 54. The biaxially oriented polyethylene film, in some embodiments, has an overall draw ratio (draw ratio in machine direction X draw ratio in cross direction) of 9 to 40.

After orientation, the biaxially oriented polyethylene film has a thickness of 10 to 70 microns in some embodiments. In some embodiments, the biaxially oriented polyethylene film has a thickness of 15 to 40 microns.

In some embodiments, the biaxially oriented polyethylene film has a 2% secant modulus of at least 300 MPa in the machine direction when measured according to ASTM D882.

In some embodiments, the biaxially oriented polyethylene film has a dart impact of at least 10 grams/micron when measured according to ASTM D1709 (Method A).

In some embodiments, depending for example on the end use application, the biaxially oriented polyethylene film can be corona treated, plasma treated, or printed using techniques known to those of skill in the art.

Following biaxial orientation, the biaxially oriented polyethylene films are laminated to a polyethylene film using a barrier adhesive as described further herein.

### Polyethylene Film

Laminates of the present invention comprise a polyethylene film that is adhered to the biaxially oriented polyethylene film with a barrier adhesive.

The polyethylene film comprises at least 50 weight percent polyethylene based on the weight of the polyethylene film, in some embodiments. The weight of polyethylene includes the weight of all of the polyethylenes (any ethylene-based polymer comprising >50 mol % ethylene monomer). The polyethylene film comprises at least 70 weight percent polyethylene, based on the weight of the polyethylene film, in some embodiments. In some embodiments, the polyethylene film comprises at least 90 weight percent of polyethylene, based on the weight of the polyethylene film. In some embodiments, the polyethylene film comprises at least 95 weight percent polyethylene, based on the weight of the polyethylene film. The polyethylene film comprises up to 100 weight percent polyethylene, based on the weight of the polyethylene film in some embodiments.

A variety of polyethylenes and blends of polyethylene can be used in the polyethylene film. Such polymers include high density polyethylene (HDPE), low density polyethylene (LDPE), ultra low density polyethylene (ULDPE), polyethylene plastomer, polyethylene elastomer, ethylene vinyl acetate copolymer, ethylene ethyl acrylate copolymer, any other polymer comprising at least 50 mol % ethylene monomer, and combinations thereof. Persons of skill in the art can select suitable commercially available ethylene-based polymers for use in the outer layer based on the teachings herein.

In various embodiments, the one or more polyethylene resins that can be used to form the polyethylene film have a density from 0.865 g/cm³ to 0.965 g/cm³. All individual values and subranges greater than or equal to 0.865 g/cm³ are included herein and disclosed herein; for example, the density of the polyethylene resin(s) can be from a lower limit of 0.975, 0.880, 0.895, 0.900, 0.905, 0.910, 0.915, 0.920 or 0.925 g/cm³. In some aspects, the polyethylene resin(s) have a density less than or equal to 0.965 g/cm³. All individual values and subranges of less than 0.965 g/cm³ are included herein and disclosed herein; for example, the polyethylene resin(s) can have a density from an upper limit of 0.960, 0.955, 0.950, 0.940, or 0.930 g/cm³. In some embodiments, polyethylene resin(s) have a density from 0.900 to 0.960 g/cm³.

The polyethylene resin(s) used to form the polyethylene film, in some embodiments, have a melt index (I₂) less than or equal to 10 g/10 minutes. All individual values and subranges from 10 g/10 minutes are included herein and disclosed herein. For example, the first linear low density polyethylene can have an 12 from an upper limit of 10, 9, 8, 7, 6, 5, 4, 3, 2, 1.5, or 1.0 g/10 minutes. In a particular aspect, the polyethylene resin(s) have an 12 with a lower limit of 0.25 g/10 minutes. All individual values and subranges from 0.01 g/10 minutes are included herein and disclosed herein. For example, the polyethylene resin(s) can have an 12 greater than or equal to 0.4, 0.5, 0.8, or 1.0 g/10 minutes.

In some embodiments, the polyethylene film is formed entirely from ethylene-based polymers having a density from 0.900 to 0.960 g/cm³ and a melt index from 0.5 to 6 g/10 minutes.

The polyethylene film can be a monolayer or a multilayer film.

In some embodiments, the polyethylene film can be a sealant film. The sealant film can be used to form a package by using the sealant film (or a sealant layer in a multilayer film) to adhere the laminate to another film or to another laminate.

The sealant film or the sealant layer of a multilayer film, in some embodiments, may comprise an ethylene-based polymer having a density from 0.900 to 0.925 g/cm³ and a melt index (I₂) from 0.1 to 20 g/10 min. In further embodiments, the ethylene-based polymer of the sealant film (or sealant layer) may have a density from 0.910 to 0.920 g/cm³, or 0.915 to 0.920 g/cm³. Additionally, the ethylene-based polymer of the sealant film (or sealant layer) may have a melt index (I₂) from 0.1 to 2 g/10 min, or from 0.5 to 1.0 g/10 min. Various commercial products are considered suitable for the sealant film. Suitable commercial examples may include ELITE™ 5400G and ELITE™ 5401G, both of which are available from The Dow Chemical Company (Midland, Mich.).

In further embodiments, the sealant film, or sealant layer of a multilayer film, may comprise additional ethylene based polymers, for example, a polyolefin plastomer, LDPE, or both. The LDPE of the sealant film or sealant layer may generally include any LDPE known to those of skill in the art. The polyolefin plastomer may have a melt index (I₂) of 0.2 to 5 g/10 min, or from 0.5 to 2.0 g/10 min. Moreover, the polyolefin plastomer may have a density of 0.890 g/cc to 0.920 g/cc, or from 0.900 to 0.910 g/cc. Various commercial polyolefin plastomers are considered suitable for the sealant film. One suitable example is AFFINITY™ PL 1881G from The Dow Chemical Company (Midland, Mich.).

When the polyethylene film is a multilayer film having a sealant layer (Layer A), such films can include a second layer (Layer B) having a top facial surface and a bottom facial surface, wherein the top facial surface of Layer B is in adhering contact with a bottom facial surface of the sealant layer (Layer A). In general, Layer B can be formed from any polymer or polymer blend known to those of skill in the art.

In some embodiments, Layer B comprises polyethylene. Layer B, in some embodiments, comprises polyethylene. Polyethylene can be particularly desirable in some embodiments as it can permit the coextrusion of Layer B with the sealant layer. In such embodiments, Layer B can comprise any polyethylene known to those of skill in the art to be suitable for use as a layer in a multilayer film based on the teachings herein. For example, the polyethylene that can be used in Layer B, in some embodiments, can be ultralow density polyethylene (ULDPE), low density polyethylene (LDPE), linear low density polyethylene (LLDPE), medium density polyethylene (MDPE), high density polyethylene (HDPE), high melt strength high density polyethylene (HMS-HDPE), ultrahigh density polyethylene (UHDPE), enhanced polyethylenes, and others.

Some embodiments of multilayer films of the present invention can include layers beyond those described above. In such embodiments comprising three or more layers, the top facial surface of the sealant layer (Layer A) would still be the top facial surface of the film. In other words, any additional layers would be in adhering contact with a bottom facial surface of Layer B, or another intermediate layer. For example, a multilayer film can further comprise other layers typically included in multilayer films depending on the application.

It should be understood that any of the foregoing layers in the polyethylene film can further comprise one or more additives as known to those of skill in the art such as, for example, antioxidants, ultraviolet light stabilizers, thermal stabilizers, slip agents, antiblock, pigments or colorants, processing aids, crosslinking catalysts, and fillers.

Multilayer films comprising the combinations of layers disclosed herein can have a variety of thicknesses depending, for example, on the number of layers, the intended use of the film, and other factors. Multilayer films of the present invention, in some embodiments, have a thickness of 20 to 200 microns (typically, 40-150 microns).

In some embodiments, the ratio of the thickness of the BOPE film to the polyethylene film is from 0.1 to 1. The ratio of the thickness of the BOPE film to the polyethylene film, in some embodiments is from 0.2 to 0.8.

Multilayer films that can be used as the polyethylene film in the laminate can be formed using techniques known to those of skill in the art based on the teachings herein. For example, for those layers that can be coextruded, such layers can be coextruded as blown films or cast films using techniques known to those of skill in the art based on the teachings herein. In particular, based on the compositions of the different film layers disclosed herein, blown film manufacturing lines and cast film manufacturing lines can be configured to coextrude multilayer films of the present invention in a single extrusion step using techniques known to those of skill in the art based on the teachings herein.

### Barrier Adhesive Layer

A barrier adhesive layer comprising polyurethane is used to adhere the BOPE film to the polyethylene film.

As set forth below in more detail below, the polyurethane in the barrier adhesive layer comprises an isocyanate component comprising a single species of polyisocyanate, and an isocyanate-reactive component comprising a hydroxyl-terminated polyester incorporated as substantially-miscible solids in a carrier solvent, the polyester formed from a single species of a linear aliphatic diol having terminal hydroxyl groups and from 2 to 10 carbon atoms, and a linear dicarboxylic acid, the polyester having a number average molecular weight from 300 to 5,000 and being solid at 25° C., and having a melting point of 80° C. or below.

The barrier adhesive layer can be prepared by (i) providing a single species of polyisocyanate (A) as an A-component (an isocyanate component); (ii) also providing a hydroxyl-terminated polyester (B) (an isocyanate reactive component), formed from a single species of a linear aliphatic diol having terminal hydroxyl groups and from 2 to 10 carbon atoms, and a single species of a linear dicarboxylic acid, the polyester having a number average molecular weight from 300 to 5000 and being solid at 25° C. and having a melting point of 80° C. or below, the hydroxyl-terminated polyester (B) being incorporated as substantially miscible solids in a carrier solvent in an amount of at least 20 percent by weight, based on the weight of (A) and the carrier solvent, to form a B-component; (b) either (i) mixing the A-component and the B-component at an NCO/OH ratio from 1 to 2 to form an adhesive mixture (I), or (ii) reacting all or a portion of the A-component and a portion of the B-component at an NCO/OH ratio of from 2 to 8 to form a prepolymer (C) and then mixing the remaining portion of the B-component and any remaining portion of the A-component with the prepolymer (C) to form an adhesive mixture (II) having an NCO/OH ratio from 1 to 2.

The isocyanate component is a liquid polyisocyanate. Preferably such is an aliphatic polyisocyanate, more preferably based on a linear aliphatic diisocyanate. A single species of this diisocyanate is used, to enable the crystallization step to occur before curing is too advanced to prevent the desired crystallization from occurring. In particular but non-limiting embodiments the polyisocyanate may be selected from a polymeric hexamethylene diisocyanate (i.e., a trimer isocyanurate of HDI), methylene diphenyl diisocyanate (MDI), dicyclohexylmethane 4,4′-diisocyanate (H₁₂MDI), and toluene diisocyanate (TDI). Preferred among these is the polymeric hexamethylene diisocyanate (i.e., the trimer isocyanurate of HDI). It is noted that the polyisocyanate generally comprises a small portion of the linear polyurethane chain than does the hydroxyl-terminated polyester, and therefore the choice of polyisocyanate appears to be less critical in determining final barrier properties than does the choice of polyester, which is discussed further hereinbelow. Nonetheless, it is found that HDI offers particularly enhanced barrier properties but at relatively higher cost. Where less stringent barrier properties are acceptable, alternative and less expensive polyisocyanates, such as MDI, make reasonable choices. In keeping with U.S. polyurethane industry custom, the polyisocyanate (the isocyanate component) constitutes the “A-component,” or “A-side,” of the formulation. (In European industry custom, such constitutes the “B-side” of the formulation.)

The polyurethane in the adhesive barrier layer also comprises a hydroxyl-terminated polyester formed from a combination of a diol and a dicarboxylic acid. For this material, the diol is a single linear aliphatic diol having from 2 to 10 carbon atoms. This diol is preferably a C3-C6 diol. In certain embodiments, n-butanediol and n-hexanediol are particularly preferred, both from the standpoint of forming an effective adhesive layer in the laminate with desirably high barrier properties and from the standpoint of availability and cost.

The dicarboxylic acid is a linear dicarboxylic acid. Such is preferably selected from adipic acid, azelaic acid, sebacic acid, and combinations thereof. Particularly preferred is adipic acid.

The hydroxyl-terminated polyester may be formed via the reaction of the diol and the dicarboxylic acid. For example, reaction of 1,6-hexanediol and adipic acid forms hexanediol adipate; reaction of 1,4-butanediol and adipic acid forms butanediol adipate; reaction of 1,6-hexanediol and azelaic acid forms hexanediol azelate; and so forth. Conditions for such reactions will be known to, or easily researched by, those skilled in the art. However, such conditions frequently include, in general, admixing the diol and the dicarboxylic acid and heating the admixture at a temperature from 100° C. to 200° C., preferably from 120° C. to 180° C., and most preferably from 140° C. to 160° C., to form the hydroxyl-terminated polyester. The resultant water formed via the condensation reaction may then be removed by distillation. Alternatively the hydroxyl-terminated polyester may be purchased in neat form where available.

It is desirable that the selected hydroxyl-terminated polyester has an OH number from 20, preferably from 100, to 350, preferably to 250. Additional and important properties of the polyester include its being in crystalline (solid) form at ambient temperature and having a melting point that is 80° C. or below; preferably 70° C. or below; more preferably 60° C. or below; and most preferably 55° C. or below. Furthermore, the number average (Mₙ) molecular weight of the polyester is preferably from 300 to 5000, and more preferably from 500 to 2000.

Whether the polyester is prepared or otherwise obtained, for use in the invention it must be combined with a carrier solvent. Alternatively, the polyester may be prepared in situ in the carrier solvent. Such carrier solvent may be selected from a variety of non-protonated solvents and combinations thereof. Non-limiting examples of such include ethyl acetate, methyl ethylketone, dioxolane, acetone and combinations thereof. Preferred among these, in certain embodiments, is ethyl acetate, for reasons of convenience, efficacy and cost. It is desirable that the polyester, which is solid at ambient temperature, as previously noted, be combined with the carrier solvent in a solids content amount ranging from 20 percent, preferably from 30 percent, more preferably from 35 percent, to 80 percent, preferably to 70 percent, preferably to 55 percent, based on the combined weight of the polyester and carrier solvent. In one particularly preferred embodiment, the polyester/solvent mixture preferably has a solids content of from 35 to 40 weight percent. For convenience, and in keeping with US polyurethane industry custom, the combination of the hydroxyl-terminated polyester (isocyanate-reactive component) and the carrier solvent may be termed herein the “B-component,” or “B-side,” of the formulation. (European industry custom generally denominates this the “A-side.”)

Generally, selection of both the polyisocyanate and the hydroxyl-terminated polyester will preferably take into account aspects of temperature. For example, as already noted, the polyisocyanates useful in the invention are liquids at ambient temperatures, i.e., from 20° C. to 25° C., and hydroxyl-terminated polyesters have relatively low melt temperatures, 80° C. or below, due to their low number average molecular weight range, i.e., Mₙ ranging from 300 to 5000. This means that the resultant adhesive can be applied at an application temperature that is relatively close to ambient (i.e., from ambient to the melt temperature of the hydroxyl-terminated polyester), which helps to ensure that the polymeric materials, e.g., films, being laminated are not degraded, deformed, or even destroyed such as could result if the adhesive had to be applied at a significantly higher temperature. Furthermore, where a polymeric material is particularly heat-sensitive, the hydroxyl-terminated polyester can be selected such that it will melt at a temperature that is even lower (e.g., 70° C. or lower, 60° C. or lower, etc.) to ensure successful application and lamination.

The adhesive formulations useful in the invention may also, in certain embodiments, include certain additional constituents. Those skilled in the polyurethane art will be aware of the wide variety of property- and process-modifying additives available. With respect to methods of preparing laminates of the present invention, however, a particular possibility may include the need or desire to modify and/or control viscosity in order to ensure application can be acceptably, and preferably optimally, carried out on a given piece of laminating equipment. In order to ensure this, viscosity may be adjusted by, for example, inclusion of a viscosity modifying additive. In one particular embodiment such may be a MODAFLOW™ (MODAFLOW is a tradename of Surface Specialties, Inc.) product, e.g., MODAFLOW™ 9200, which is described as an acrylic polymer-based flow/leveling modifier that also enhances wetting by modifying surface tension. Where inclusion of one or more optional additives is desired, it is preferably in an amount from 1 weight percent (wt %), preferably 3 wt %, more preferably 4 wt %, to 8 wt %, preferably 6 wt %, still more preferably 5 wt %, based upon total weight of the formulation including both the A-component and the B-component. Alternative viscosity modifying additives may include, for example, other acrylate, including acrylate-based, materials. Other property-modifying additives may also be selected, such as those affecting other barrier properties, odor, clarity, ultraviolet light stability, flexibility, temperature stability, and so forth. Where any additive is selected, such is typically added to the B-component prior to combination and reaction of such with the A-component.

Those skilled in the art will be very aware of typical methods of combining the polyisocyanate A-component (the isocyanate component) and the hydroxyl-terminated polyester (isocyanate-reactive component)/carrier solvent B-component (which may include additives). In general, these two major components are combined and mixed close to the time of application for lamination purposes, preferably just prior thereto. By “just prior” is meant preferably within about 1 minute or less of application to the polymeric material, or materials, to be laminated. “Closely prior” is used to indicate any time period that does not undesirably interfere with either application of the adhesive to the polymeric film or films and/or attainment of the desired enhanced barrier property or properties in the final laminate. The polyester is desirably in molten or solute form in its carrier solvent and is preferably substantially, more preferably fully, miscible with the solvent, i.e., “substantially” meaning that it is preferably at least 95 wt %, more preferably at least 98 wt %, and most preferably at least 99 wt %, miscible, and the polyisocyanate is in liquid form, thereby enabling convenient mixing and maximizing of the degree and uniformity of reaction. Once combined, the reacting mixture is termed the adhesive mixture.

In another embodiment, it is also possible to pre-react all (or a larger portion) of the A-component with a (smaller) portion of the B-component, so as to form a low viscosity isocyanate-capped prepolymer, followed by reacting the remainder of the B-component with the prepolymer. The final NCO/OH ratio still ranges from 1 to 2, preferably from 1.2 to 1.6, at the point of application of the adhesive mixture composition to the polymeric material, but in making the prepolymer the NCO/OH ratio is preferably from 2 to 8. The prepolymer route may be one method of preventing the viscosity from being too low at the application temperature, which may then enable tighter viscosity control via other methods such as the use of viscosity modifiers/leveling agents. In preferred embodiments all of the A-component is reacted with an appropriate portion of the B-component. However, in alternative embodiments, use of even 25 wt % of the A-component in a prepolymer will significantly increase viscosity. Preferably at least 50 wt % of the B-component is pre-reacted when a prepolymer route is pursued for viscosity adjustment purposes.

Ultimately an NCO/OH ratio of 1 is theoretically desired for the polyurethane adhesive, regardless of whether or not a prepolymer route is employed. However, because the polyester will, in many instances, contain some residual water from the polyester condensation reaction, an excess of polyisocyanate is typically used, up to an NCO/OH ratio of about 2, preferably from 1.2 to 1.6.

### Manufacture of Laminate

A laminate of the present invention may be formed as follows in some embodiments. A single species of polyisocyanate (A) as an A-component (an isocyanate component) is provided along with \a hydroxyl-terminated polyester (B) (an isocyanate reactive component), formed from a single species of a linear aliphatic diol having terminal hydroxyl groups and from 2 to 10 carbon atoms, and a single species of a linear dicarboxylic acid, the polyester having a number average molecular weight from 300 to 5000 and being solid at 25° C. and having a melting point of 80° C. or below. The hydroxyl-terminated polyester (B) is incorporated as substantially miscible solids in a carrier solvent in an amount of at least 20 percent by weight, based on the weight of (A) and the carrier solvent, to form a B-component. Then, either (1) the A-component and the B-component are mixed at an NCO/OH ratio from 1 to 2 to form an adhesive mixture (I), or (2) all or a portion of the A-component and a portion of the B-component are reacted at an NCO/OH ratio of from 2 to 8 to form a prepolymer (C) and then the remaining portion of the B-component and any remaining portion of the A-component are mixed with the prepolymer (C) to form an adhesive mixture (II) having an NCO/OH ratio from 1 to 2. Next, a layer of at least one of the adhesive mixtures (I) and (II) is applied to the polyethylene film (described), with the adhesive mixture (I) or (II) having been prepared closely prior to applying the layer to the polyethylene film. The BOPE film (described above) is positioned proximal to the layer and distal to the polyethylene film, such that the layer is between the polyethylene film and the BOPE film. The adhesive mixture (I) or (II) is allowed to fully react, at a temperature of 50° C. or higher, and then cure under conditions such that crystalline polyester domains are formed prior to completion of cure, such that a laminate is formed. Additional details are provided below.

Those skilled in the art will be well aware of the type of equipment typically used or useful for lamination and constraints that may result from selection thereof. For example, so-called high speed laminating machines may require a viscosity of the adhesive formulation (comprising the A-component, including any additives, and the B-component) ranging from 300 to 2000 centipoise (cPs, 300 to 2000 millipascal·second, mPa·s), preferably from 400 to 1000 cPs (400 to 1000 mPa.$) at the laminating temperature. This helps to enable coating weights that typically range from 1 to 3 pounds per ream (lb/rm, 1.6 to 4.9 grams per square meter, g/m²), preferably 1.5 lb/rm (2.4 g/m²). In general, the lamination equipment may be operated preferably at a rate of from 30 m/min, more preferably from 50 m/min, and still more preferably from 100 m/min, to 500 m/min, more preferably to 400 m/min, and still more preferably from 300 m/min. In certain particular embodiments the laminating equipment is most preferably operated at a rate from 150 m/min to 250 m/min. The laminating temperature (“lamination” or “laminating” including both application of the adhesive as a layer on at least one polymeric film and positioning of the two polymeric films such that the adhesive layer is between them) may be adjusted according to the polymeric materials being laminated, but as previously noted, it is preferably 80° C. or below, more preferably 70° C. or below, even more preferably 60° C. or below, and most preferably 55° C. or below. Accordingly, for reference purposes, the above-described viscosity ranges should correspond to at least one of the above-listed temperatures, e.g., from approximately ambient to 80° C.

Following application of the adhesive mixture on the polyethylene film, i.e., positioning of the adhesive layer proximal to the polyethylene film, the polyethylene film is preferably subjected to a drying protocol to remove the carrier solvent from the adhesive mixture. Most conveniently, in one embodiment, the polyethylene film may be transported through a drying tunnel for a time that is preferably sufficient to remove most, more preferably substantially all, i.e., at least 95 weight percent (wt %), more preferably at least 98 wt %, of the carrier solvent therefrom. In certain particular but non-limiting embodiments the drying temperature may vary from 60° C. to 90° C. and time may vary from 0.1 second to 10 seconds, preferably 1 second to 6 seconds. As previously noted, it is desirable not to use too high a temperature such that the formation of crystalline domains is not undesirably diminished or disrupted. In this embodiment, the solvent is removed prior to the polyethylene film being coupled with the BOPE film at the nip. Positioning of the BOPE film following drying is such that it is proximal to the adhesive layer but distal to the polyethylene film, i.e., the adhesive layer is between the two films.

Following lamination the now-adhered, three-layer structure is nipped at a temperature that is preferably higher than the lamination temperature. In this embodiment, the nip roll temperature is preferably 40° C. or higher, more preferably 60° C. or higher, still more preferably 80° C. or higher. Such is preferably accomplished at a temperature that is sufficiently high to ensure excellent bond strength of the polymeric film layers without degradation of either the polymeric films or of the adhesive. Following nip, the three-layer structure is then chilled by rolling on a chill roll, which allows the adhesive formulation to complete reaction and begin, and then compete, its cure stage. For this purpose, the chill roll temperature is preferably 40° C. or below, more preferably 20° C. or below, and still more preferably 5° C. or below. Time on the chill roll will generally depend upon the configuration of the laminating equipment of which it is part and the overall lamination speed, which is discussed hereinabove. Additional chill equipment may also be used to enhance the crystallization of the adhesive before it becomes fully cured, if desired. Following the chill cycle, the laminate is rolled onto the reel and the reel is stored, usually at ambient temperature, for a period of time to enable full completion of the reaction and cure.

The result of this process is that a relatively slow urethane-forming reaction is begun at the point of first mixing the A-component and B-component and continues, wherein crystalline polyester domains are formed prior to completion of the reaction and substantial cure of the adhesive mixture and maintained permanently in the adhesive layer of the final cured laminate. It is important that crystalline polyester domains are, indeed, formed, which means that curing rate is desirably controlled to ensure this. For example, if curing temperature is too high or a particularly reactive polyisocyanate is selected, crystalline domains may not form and the advantages of the invention are not attained. For example, some MDI-based prepolymers and TDI-based prepolymers are highly reactive and may result in insufficient crystallization, if any, such that the oxygen transmission rate of the final laminate is unacceptably high. In general, then, desirably conditions include a reaction/curing temperature that preferably does not exceed 35° C., more preferably 30° C., and a time that is preferably at least 3 days, more preferably at least 5 days, and most preferably at least 7 days. The presence of crystalline domains may be confirmed via differential scanning calorimetry (DSC) of the adhesive alone. This DSC is preferably done after subjection of the adhesive system to a heating and cooling cycle that correspond to what would be occurring on the relevant lamination equipment. Such a DSC enables observation of the melting endotherm and the crystallization exotherm. An alternative analytical method to confirm the formation of crystalline domains is polarized light microscopy.

### Laminates

Laminates of the present invention comprise a biaxially oriented polyethylene film laminated to a polyethylene film using a barrier adhesive layer comprising a polyurethane (as more fully set forth in the various embodiments described above above). The inventive laminate can advantageously provide a combination of desirable barrier properties and mechanical properties. For example, in some embodiments, laminates of the present invention can provide a good barrier to oxygen and/or water vapor both before and after flex treatment while also exhibiting desirable mechanical properties. In some embodiments, such desirable properties are provided in the absence of a typical barrier layer in the film structures such as polyamide, ethylene vinyl alcohol, or a foil layer.

In some embodiments, a laminate of the present invention has an oxygen gas transmission rate of 700 cc/[m²-day] or less when measured according to ASTM D3985-05.

The multilayer structures, in some embodiments, can also have acceptable stiffness, good optical properties, excellent toughness, and low temperature sealing performance.

### Articles

Multilayer structures of the present invention can be used to form articles such as packages. Such articles can be formed from any of the multilayer structures described herein.

Examples of packages that can be formed from multilayer structures of the present invention can include flexible packages, pouches, stand-up pouches, and pre-made packages or pouches. In some embodiments, multilayer films of the present invention can be used for food packages. Examples of food that can be included in such packages include meats, cheeses, cereal, nuts, juices, sauces, and others. Such packages can be formed using techniques known to those of skill in the art based on the teachings herein and based on the particular use for the package (e.g., type of food, amount of food, etc.).

### Test Methods

Unless otherwise indicated herein, the following analytical methods are used in describing aspects of the present invention:

### Density

Samples for density measurement are prepared according to ASTM D 1928. Polymer samples are pressed at 190° C. and 30,000 psi (207 MPa) for three minutes, and then at 21° C. and 207 MPa for one minute. Measurements are made within one hour of sample pressing using ASTM D792, Method B.

### Melt Index

Melt indices I₂ (or I2) and I₁₀ (or I10) are measured in accordance with ASTM D-1238 at 190° C. and at 2.16 kg and 10 kg load, respectively. Their values are reported in g/10 min.

### Crystallization Elution Fractionation (CEF)

Crystallization Elution Fractionation (CEF) is described by Monrabal et al, Macromol. Symp. 257, 71-79 (2007). The instrument is equipped with an IR-4 detector (such as that sold commercially from PolymerChar, Spain) and a two angle light scattering detector Model 2040 (such as those sold commercially from Precision Detectors). The IR-4 detector operates in the compositional mode with two filters: C006 and B057. A 10 micron guard column of 50×4.6 mm (such as that sold commercially from PolymerLabs) is installed before the IR-4 detector in the detector oven. Ortho-dichlorobenzene (ODCB, 99% anhydrous grade) and 2,5-di-tert-butyl-4-methylphenol (BHT) (such as commercially available from Sigma-Aldrich) are obtained. Silica gel 40 (particle size 0.2-0.5 mm) (such as commercially available from EMD Chemicals) is also obtained. The silica gel is dried in a vacuum oven at 160° C. for about two hours before use. Eight hundred milligrams of BHT and five grams of silica gel are added to two liters of ODCB. ODCB containing BHT and silica gel is now referred to as “ODCB.” ODBC is sparged with dried nitrogen (N₂) for one hour before use. Dried nitrogen is obtained by passing nitrogen at <90 psig over CaCO₃ and 5 Å molecular sieves. Sample preparation is done with an autosampler at 4 mg/ml under shaking at 160° C. for 2 hours. The injection volume is 300 μl. The temperature profile of CEF is: crystallization at 3° C./min from 110° C. to 30° C., thermal equilibrium at 30° C. for 5 minutes (including Soluble Fraction Elution Time being set as 2 minutes), and elution at 3° C./min from 30° C. to 140° C. The flow rate during crystallization is 0.052 ml/min. The flow rate during elution is 0.50 ml/min. The data are collected at one data point/second.

The CEF column is packed with glass beads at 125 μm±6% (such as those commercially available from MO-SCI Specialty Products) with ⅛ inch stainless tubing according to US 2011/0015346 A1. The internal liquid volume of the CEF column is between 2.1 and 2.3 mL. Temperature calibration is performed by using a mixture of NIST Standard Reference Material Linear polyethylene 1475a (1.0 mg/ml) and Eicosane (2 mg/ml) in ODCB. The calibration consists of four steps: ⁽¹⁾ Calculating the delay volume defined as the temperature offset between the measured peak elution temperature of Eicosane minus 30.00° C.; ⁽²⁾ Subtracting the temperature offset of the elution temperature from the CEF raw temperature data. It is noted that this temperature offset is a function of experimental conditions, such as elution temperature, elution flow rate, etc.; ⁽³⁾ Creating a linear calibration line transforming the elution temperature across a range of 30.00° C. and 140.00° C. such that NIST linear polyethylene 1475a has a peak temperature at 101.00° C., and Eicosane has a peak temperature of 30.00° C., ⁽⁴⁾ For the soluble fraction measured isothermally at 30° C., the elution temperature is extrapolated linearly by using the elution heating rate of 3° C./min. The reported elution peak temperatures are obtained such that the observed comonomer content calibration curve agrees with those previously reported in U.S. Pat. No. 8,372,931.

A linear baseline is calculated by selecting two data points: one before the polymer elutes, usually at temperature of 26° C., and another one after the polymer elutes, usually at 118° C. For each data point, the detector signal is subtracted from the baseline before integration.

Molecular Weight of High Density Fraction (MW_{HDF>95}) and High Density Fraction Index (I_{HDF>95})

The polymer molecular weight can be determined directly from LS (light scattering at 90 degree angle, Precision Detectors) and the concentration detector (IR-4, Polymer Char) according to the Rayleigh-Gans-Debys approximation (A. M. Striegel and W. W. Yau, Modern Size-Exclusion Liquid Chromatography, 2nd Edition, Page 242 and Page 263, 2009) by assuming a form factor of 1 and all the virial coefficients equal to zero. Baselines are subtracted from the LS (90 degree) and IR-4 (measurement channel) chromatograms. For the whole resin, integration windows are set to integrate all the chromatograms in the elution temperature (temperature calibration is specified above) ranging from 25.5 to 118° C. The high density fraction is defined as the fraction that has an elution temperature higher than 95.0° C. in CEF. Measuring the MW_{HDF>95} and I_{HDF>}95 includes the following steps:
(1) Measuring the interdetector offset. The offset is defined as the geometric volume offset between LS detector with respect to the IR-4 detector. It is calculated as the difference in elution volume (mL) of the polymer peak between the IR-4 and LS chromatograms. It is converted to the temperature offset by using the elution thermal rate and elution flow rate. A high density polyethylene (with no comonomer, melting index I₂ of 1.0, polydispersity or molecular weight distribution M_{w}/Mₙ approximately 2.6 by conventional gel permeation chromatography) is used. The same experimental conditions as the CEF method above are used except for the following parameters: crystallization at 10° C./min from 140° C. to 137° C., thermal equilibrium at 137° C. for 1 minute as the Soluble Fraction Elution Time, and elution at 1° C./min from 137° C. to 142° C. The flow rate during crystallization is 0.10 ml/min. The flow rate during elution is 0.80 ml/min. The sample concentration is 1.0 mg/ml.
(2) Each data point in the LS chromatogram is shifted to correct for the interdetector offset before integration.
(3) Molecular weight at each retention temperature is calculated as the baseline subtracted LS signal/the baseline subtracted IR4 signal/MW constant (K).
(4) The baseline subtracted LS and IR-4 chromatograms are integrated in the elution temperature range of 95.0 to 118.0° C.
(5) The Molecular weight of the high density fraction (MW_{HDF>95}) is calculated according to

MW_{HDF>95}=∫₉₅¹¹⁸Mw·C·dT/∫₉₅¹¹⁸C·dT

where Mw is the molecular weight of the polymer fraction at the elution temperature T and C is the weight fraction of the polymer fraction at the elution temperature T in the CEF, and

∫₂₅¹¹⁸C·dT=100%
(6) High density fraction index (I_{HDF>95}) is calculated as

I_{HDF>95}=∫₉₅¹¹⁸Mw·C·dT

where Mw in is the molecular weight of the polymer fraction at the elution temperature T in the CEF.

The MW constant (K) of CEF is calculated by using NIST polyethylene 1484a analyzed with the same conditions as for measuring interdetector offset. The MW constant (K) is calculated as “(the total integrated area of LS) of NIST PE1484a/(the total integrated area) of IR-4 measurement channel of NIST PE 1484a/122,000”.

The white noise level of the LS detector (90 degree) is calculated from the LS chromatogram prior to the polymer eluting. The LS chromatogram is first corrected for the baseline correction to obtain the baseline subtracted signal. The white noise of the LS is calculated as the standard deviation of the baseline subtracted LS signal by using at least 100 data points prior to the polymer eluting. Typical white noise for LS is 0.20 to 0.35 mV while the whole polymer has a baseline subtracted peak height typically around 170 mV for the high density polyethylene with no comonomer, 12 of 1.0, polydispersity M_{w}/Mₙ approximately 2.6 used in the interdetector offset measurements. Care should be maintained to provide a signal to noise ratio (the peak height of the whole polymer to the white noise) of at least 500 for the high density polyethylene.

### Ultimate Tensile Stress and 2% Secant Modulus

The ultimate tensile stress and 2% secant modulus are measured in accordance with ASTM D-882.

### Puncture Strength

The puncture strength of the film is measured on a tensile tester (Model 5965 from Instron) using the compression method. A film sample is clamped in a holder to provide a sample area having a diameter of 102 mm. Then, a puncture probe having a 12 mm diameter round profile moves vertically downward at a speed of 250 mm/minute. The test is stopped when the puncture probe passes completely though the film sample. The energy at break is recorded based on a measurement from mechanical testing software (Bluehill3).

### Dart Impact

The dart impact strength is measured in accordance with ASTM D-1709 (Method A).

### Oxygen Transmission Rate

The oxygen transmission rate is measured in accordance with ASTM D-3985 using a MOCON OX-TRAN Model 2/21 measurement device at a temperature of 23° C. at a relative humidity of 0% using purified oxygen. When the barrier data of the sample is over 200 cc/m²-day, a mask is applied to reduce the testing area from 50 cm² to 5 cm² to acquire data with a larger mass of penetrated oxygen over the testing range.

### Water Vapor Transmission Rate

The water vapor transmission rate is measured in accordance with ASTM F-1249 using a MOCON PERMA-TRAN-W 3/33 measurement device at a temperature of 37.8° C. at a relative humidity of 100%. Tests were conducted on 50 cm² film samples.

### Flex Treatment

The flex treatment was conducted on a Gelboflex machine (Gelvo type Flex-Cracking Tester, Gelvo type Flex-Cracking Tester) following ASTM F392.

### Curling Degree Angle by Cross Cutting Method

After the lamination process is complete and the lamination machine stops, the system tension is maintained and a knife is used to do a cross cutting at the web before the rewinder. The curling film's angle to the web substrate is measured with a protractor.

### Tunneling Percentage by Lay Down Method

After the lamination process is completed and the lamination machine stops, the tension is released and a 400*400 mm size laminate is cut and laid down on a horizontal surface for 5 minutes. The percentage of tunneling or delamination area percentage is then visually estimated.

Measurement on Max Telescoping Length from Roll Face End

After the lamination process is complete and the lamination machine stops, the rewind roll is taken down, and a ruler is used to measure the length of the maximum telescoping layer's edge to the neat roll end face.

Some embodiments of the invention will now be described in detail in the following Examples.

### Examples

The following materials are used in the Examples.

### Biaxially Oriented Polyethylene Film (“BOPE Film”)

The BOPE Film is model Lightweight PE film (DL) having a thickness of 25 microns (after orientation), commercially available from Guangdong Decro Film New Materials CO. Ltd. The film is a biaxially oriented, monolayer film.

The BOPE film is formed from a polyethylene composition from The Dow Chemical Company comprising at least two linear low density polyethylenes from the The Dow Chemical Company. The polyethylene composition has a density of 0.925 g/cm³ and a melt index (I₂) of 1.7 g/10 minutes, and is characterized by having an MW_{HDF>95} of 137.9 kg/mol and an I_{HDF>95} of 67.4 kg/mol when measured as described in the TEST METHODS above.

### Polyethylene Film (“PE Film”)

The PE Film is a 50 micron blown polyethylene film having the following structure:

TABLE 1
Formulation of PE Film

| Lamination | | Core | | Sealant | |
|---|---|---|---|---|---|
| layer (15 μm) | | Layer (20 μm) | | layer (15 μm) | |
| 75% | LL0220AA | 75% | 222WT | 75% | DOWLEX |
| | | | | | 2045.11G |
| 24% | Lotrène | 24% | Lotrène | 24% | Lotrène |
| | LDPE | | LDPE | | LDPE |
| | FD0274 | | FD0274 | | FD0274 |
| 1% | PEA-3S | 1% | PEA-3S | 1% | PEA-3S |

LL0220AA is LLDPE from Shanghai SECCO Petrochemical Company Limited. Lotréne LDPE FD0274 is LDPE from Qatar Petrochemical Company. 222WT is LLDPE from SINOPEC SABIC Tianjin Petrochemical Co. Ltd. PEA-3S is a multifunctional processing aid from Tianjin Yuzhen Trading Company Limited.

The PE Film is coextruded on a 3-layer blown line (Type 2200, Reifenhauser Group). The process parameters are as follows: die diameter=500 mm; die gap=2.5 mm; blow-up ratio=2.0; haul-off speed=38.7 m/minute; output=340 kg/hour; layer ratio=3:4:3.

### Biaxially Oriented Polyethylene Terephthalate Film (“BOPET Film”)

The BOPET film is a 12 micron film commercially available from Jiangsu Zhongda New Materials Company Limited.

### General Solvent-Based Adhesive (“SB Adhesive”)

The SB Adhesive is ADCOTE™ 545S/F, a solvent based adhesive commercially available from the Dow Chemical Company.

### Barrier Adhesive Comprising Polyurethane (“Barrier Adhesive”)

The Barrier Adhesive is a two component solvent-based polyurethane adhesive prepared as described above in the Barrier Adhesive Layer Section. The polyurethane adhesive is prepared by (i) providing a single species of polyisocyanate (A) as an A-component (an isocyanate component); (ii) also providing a hydroxyl-terminated polyester (B) (an isocyanate reactive component), formed from a single species of a linear aliphatic diol having terminal hydroxyl groups and from 2 to 10 carbon atoms, and a single species of a linear dicarboxylic acid, the polyester having a number average molecular weight from 300 to 5000 and being solid at 25° C. and having a melting point of 80° C. or below, the hydroxyl-terminated polyester (B) being incorporated as substantially miscible solids in a carrier solvent in an amount of at least 20 percent by weight, based on the weight of (A) and the carrier solvent, to form a B-component; and (iii) mixing the A-component and the B-component at an NCO/OH ratio from 1 to 2 to form the polyurethane adhesive. The polyurethane comprises an isocyanate component comprising a single species of polyisocyanate; and n isocyanate-reactive component comprising a hydroxyl-terminated polyester incorporated as substantially-miscible solids in a carrier solvent, the polyester formed from a single species of a linear aliphatic diol having terminal hydroxyl groups and from 2 to 10 carbon atoms, and a linear dicarboxylic acid, the polyester having a number average molecular weight from 300 to 5,000 and being solid at 25° C., and having a melting point of 80° C. or below.

Additional information regarding preparation of such adhesives can be found in U.S. Pat. No. 6,589,384, which is hereby incorporated by reference.

Five laminates are prepared having the structures shown in Table 2:

TABLE 2

| Sample | Structure |
|---|---|
| Inventive Laminate | BOPE Film/Barrier Adhesive/PE Film |
| Comparative-1 | BOPE Film/SB Adhesive/PE Film |
| Comparative-2 | PE Film/SB Adhesive/PE Film |
| Comparative-3 | BOPET Film/SB Adhesive/PE Film |
| Comparative-4 | PE Film/Barrier Adhesive/PE Film |
| Comparative-5 | BOPET Film/Barrier Adhesive/PE Film |

The adhesive lamination is conducted on a Nordmeccanica Labo Combi 400 pilot coater. The processing parameters are listed in Table 3:

TABLE 3

| Processing Parameters | Barrier Adhesive | SB Adhesive |
|---|---|---|
| Adhesive running solid | 33% | 30% |
| Dry coating weight | 3.0 gsm | 3.0 gsm |
| Drying condition | 3 oven zones with increase | |
| | profile setting 55° C., 65° C., 75° C. | |
| Curing Condition | 25° C., 7 days | 45° C., 2 days |
| of the laminate | | |

Three criteria are used to evaluate the processability of the adhesive lamination (as described in the above Test Methods section): (1) Curling degree angle by cross cutting method; (2) Tunneling percentage by lay down method; and (3) Measurement on max Telescoping length from roll face end.

The Barrier Adhesive has almost no green bond which leads to tunneling/telescoping issue especially when unmatched tensions exist. For example, with Comparative-3, the BOPET/blown PE laminate structure, the BOPET film has a high modulus and is difficult to stretch; in contrast, the blown PE film is easy to stretch at relatively low tensile. This leads to a curling issue. Another example is the blown PE/blown PE structure, where a higher tension must be applied to the coated substrate, and still results in unmatched tension between the two films and curling.

Due to differences in tensions between the films, the tension profiles for the Inventive Laminate, Comparative-4 and Comparative-5 had to be adjusted to minimize curling. To match the tensions of the films and reduce the curling after lamination, the tensions and line speeds are adjusted. The tension profiles for the formation of these laminates are shown in Table 4:

TABLE 4

| | Unwinder A | Unwinder B | Rewinder | Line |
|---|---|---|---|---|
| | Tension, | Tension, | Tension | Speed |
| Sample | (N/400 mm) | (N/400 mm) | (N/400 mm) | (m/min) |
| Inventive Laminate | 16.9 | 4.7 | 27.8 | 100 |
| Unwinder A | | | | |
| (BOPE); | | | | |
| Unwinder B | | | | |
| (Blown PE) | | | | |
| Comparative-4 | 8.2 | 4.7 | 24.1 | 100 |
| Unwinder A | 12.3 | 4.7 | 24.1 | 100 |
| (Blown PE); | | | | |
| Unwinder B | | | | |
| (Blown PE) | | | | |
| Comparative-5 | 23.1 | 3.7 | 33.9 | 100 |
| Unwinder A | | | | |
| (BOPET); | | | | |
| Unwinder B | | | | |
| (Blown PE) | | | | |

These three laminates are evaluated for each of the three criteria mentioned above, and the results are shown in Table 5. For each of the three criteria noted above, the Inventive Laminate is defect free. Comparative-4 exhibits a curling issue. With high unwinding A tension (12.3N), the curling still cannot be fixed but the telescoping issue occurs when the tension is reduced to low unwinding tension A (8.2N) gradually. Comparative-5 has a curling issue (to the blown PE side) and a tunneling issue after tension release. The curling issue is due to unmatched tension of the two films caused by residue stress in the blown PE film. In addition, the Barrier Adhesive delivers low green bond strength, so the unmatched tension causes tunneling issues as well. The results are shown as below Table.5:

TABLE 5

| | | | Max |
|---|---|---|---|
| | | Tunneling | Telescoping |
| | Curling degree | percentage | length |
| | angle by cross | by lay down | from roll |
| Samples | cutting method | method | face end |
| Inventive Laminate | <5° | 0 | 0 mm |
| Comparative-4 | 20-30° to | 2-5% | 5 mm |
| | unwinder | | |
| | A side | | |
| Comparative-5 | 20-30° to | 40-50% | 2 mm |
| | unwinder | | |
| | B side | | |

The oxygen transmission rate (OTR) and water vapor transmission rate (WVTR) properties of the sample laminates are used as the criteria for comparing barrier performance. Given the complexity and randomness of defects happening on laminates during flex treatment, more specimens from flexing treated sample laminates are tested to ensure the consistency of barrier performance can be verified.

As shown in Table.6, the existence of the Barrier Adhesive layer can dramatically reduce the OTR of the Inventive Laminate compared to the SB Adhesive layer used in Comparative-1 with the same 25 μm BOPE+50 μm blown PE substrate films. Even for Comparative-2 with higher total thickness by laminating two 50 μm blown PE films, its OTR is still much higher than the Inventive Laminate.

The BOPET layer of Comparative-3 can provide excellent inherent oxygen barrier over polyolefin materials. However, as shown in Table 7, after 2700 cycles of flex treatment, the OTR of Comparative-3 is sharply decreased due to its inferior flex resistance. In contrast, the OTR of the Inventive Laminate can be maintained at a relatively low level due to the BOPE Film.

Although the Inventive Laminate shows slightly higher WVTR than Comparative-2 as shown in Table 6, two specimens of Comparative-2 lose their advantages after flex treatment as shown in Table 8, which shows a failure in Comparative-2 in maintaining their barrier to water vapor. Comparative-3 cannot demonstrate WVTR as good as laminates with the full PE Films, and this worsens after flex treatment. By comparison, the Inventive Laminate and Comparative-1 structure show consistent WVTR performance because of the BOPE Film.

When the same Barrier Adhesives are used, as shown in Table 6, the Inventive Laminate has a higher OTR than Comparative-4 and Comparative-5. Nevertheless, according to the data in Table 7, the OTR of Comparative-4 is increased after flex treatment. Although 3/4 of the Comparative-4 specimens are still better than the Inventive Laminate, specimen-4 encounters failure (>2000 cc/m²-day), which results in the weakness point of overall barrier properties. As for Comparative-5, it loses the consistency of barrier performance in most of its data points after flex treatment.

The advantage of the BOPE Film in combination with the Barrier Adhesive regarding maintaining the barrier against flex treatment can be further demonstrated in WVTR. As shown in Tables 6 and 8, even though the difference between the laminates is close, the WVTRs of Comparative-4 and Comparative-5 become much higher than the Inventive Laminate after flex treatment. There is nearly no change in the WVTR of the Inventive Laminate.

TABLE 6

| | OTR* (cc/m²-day) | | | WVTR (gm/m²-day) | | |
|---|---|---|---|---|---|---|
| Sample | Specimen-1 | Specimen-2 | Avg | Specimen-1 | Specimen-2 | Avg |
| Inventive | 624 | 418 | 521 | 4.83 | 4.65 | 4.74 |
| Laminate | | | | | | |
| Comparative-1 | 1847 | 1781 | 1814 | 4.75 | 4.63 | 4.69 |
| Comparative-2 | 1547 | 1483 | 1515 | 3.41 | 3.37 | 3.39 |
| Comparative-3 | 121 | 117 | 119 | 6.98 | 6.94 | 6.96 |
| Comparative-4 | 50 | 64 | 57 | 3.39 | 3.27 | 3.33 |
| Comparative-5 | 23 | 23 | 23 | 5.75 | 5.77 | 5.76 |

*sample area for OTR test:
Inventive Laminate: 5 cm²;
Comparative-1: 5 cm²;
Comparative-2: 5 cm²;
Comparative-3: 50 cm²;
Comparative-4: 50 cm²;
Comparative-5: 50 cm².

TABLE 7

| | OTR* (cc/m²-day) after 2700 cycles flex treatment | | | | |
|---|---|---|---|---|---|
| Sample | Specimen-1 | Specimen-2 | Specimen-3 | Specimen-4 | AVG |
| Inventive | 487 | 656 | 641 | 546 | 583 |
| Laminate | | | | | |
| Comparative-3 | >2000 | >2000 | >2000 | >2000 | NA |
| | Out of | Out of | Out of | Out of | |
| | range | range | range | range | |
| Comparative-4 | 89 | 131 | 137 | >2000 | NA |
| | | | | Out of | |
| | | | | Range | |
| Comparative-5 | 42 | >2000 | >2000 | >2000 | NA |
| | | Out of | Out of | Out of | |
| | | Range | Range | Range | |

*sample area for OTR test: 5 cm².

TABLE 8

| | WVTR (gm/m²-day) after 2700 cycles flex treatment | | | | |
|---|---|---|---|---|---|
| Sample | Specimen-1 | Specimen-2 | Specimen-3 | Specimen-4 | AVG |
| Inventive | 4.42 | 4.33 | 4.82 | 4.84 | 4.60 |
| Laminate | | | | | |
| Comparative-1 | 4.96 | 5.15 | 4.70 | 5.07 | 4.97 |
| Comparative-2 | 3.20 | 7.24 | >200 | >200 | NA |
| | | | Out of | Out of | |
| | | | range | range | |
| Comparative-3 | 35.17 | >200 | 79.78 | 42.86 | NA |
| | | Out of | | | |
| | | range | | | |
| Comparative-4 | 5.76 | 62.56 | 36.01 | >200 | NA |
| | | | | Out of | |
| | | | | range | |
| Comparative-5 | 109.84 | 71.33 | >200 | >200 | NA |
| | | | Out of | Out of | |
| | | | range | range | |

The mechanical properties of the Inventive Laminate are also evaluated. As shown in Table 9, the excellent mechanical properties of the BOPE Film in the Inventive Laminate can further strengthen the dart resistance, puncture resistance, tensile stress and modulus of total structure significantly over general polyethylene films.

TABLE 9

| | | | Tensile | | | |
|---|---|---|---|---|---|---|
| | | | stress | | 2% Secant | |
| | Dart | Puncture | at break | | Modulus | |
| | Impact | (Energy | (MPa) | | (MPa) | |
| Samples | (g) | at break, J) | MD | TD | MD | TD |
| Inventive | 747 | 1.55 | 35.8 | 72.2 | 387.0 | 634.8 |
| Laminate | | | | | | |
| Comparative-1 | 831 | 1.57 | 37.1 | 74.2 | 354.5 | 626.9 |
| Comparative-2 | 249 | 1.11 | 24.9 | 16.7 | 260.9 | 287.5 |
| Comparative-3 | 831 | 0.84 | 53.4 | 50.5 | 931.3 | 978.6 |
| Comparative-4 | 78 | 1.14 | 25.7 | 21.1 | 272.6 | 315.2 |
| Comparative-5 | 735 | 0.84 | 48.4 | 53.6 | 999.3 | 1053.1 |

1. A laminate comprising:
(a) a biaxially oriented polyethylene (BOPE) film comprising a polyethylene composition, wherein the polyethylene composition has a density of 0.910 to 0.940 g/cm³, an MW_{HDF>95} greater than 135 kg/mol and an I_{HDF>95} greater than 42 kg/mol, wherein the BOPE film comprises at least 50 weight percent of the polyethylene composition based on the weight of the BOPE film;
(b) a barrier adhesive layer comprising polyurethane; and
(c) a polyethylene film,
wherein the barrier adhesive layer adheres the BOPE film to the polyethylene film and wherein the laminate has an oxygen gas transmission rate of 700 cc/[m²-day] or less when measured according to ASTM D3985-05.

2. The laminate of claim 1, wherein the BOPE film is oriented in the machine direction at a draw ratio from 2:1 to 6:1 and in the cross direction at a draw ratio from 2:1 to 9:1.

3. The laminate of claim 1, wherein the BOPE film has an overall draw ratio (draw ratio in machine direction X draw ratio in cross direction) of 8 to 54.

4. The laminate of claim 1, wherein the ratio of the draw ratio in the machine direction to the draw ratio in the cross direction is from 1:1 to 1:2.5.

5. The laminate of claim 1, wherein the BOPE film is either reverse printed or surface printed.

6. The laminate of claim 1, wherein the polyurethane in the barrier adhesive layer comprises:
an isocyanate component comprising a single species of polyisocyanate; and
an isocyanate-reactive component comprising a hydroxyl-terminated polyester incorporated as substantially-miscible solids in a carrier solvent, the polyester formed from a single species of a linear aliphatic diol having terminal hydroxyl groups and from 2 to 10 carbon atoms, and a linear dicarboxylic acid, the polyester having a number average molecular weight from 300 to 5,000 and being solid at 25° C., and having a melting point of 80° C. or below.

7. The laminate of claim 1, wherein the BOPE film is a multilayer film.

8. The laminate of claim 1, wherein the BOPE film is a monolayer film.

9. The laminate of claim 1, wherein the polyethylene film comprises at least 50 weight percent polyethylene based on the total weight of the polyethylene film.

10. The laminate of claim 1, wherein the polyethylene film comprises at least one of a high density polyethylene, a low density polyethylene, a linear low density polyethylene, a polyethylene plastomer, a polyethylene elastomer, an ethylene vinyl acetate copolymer, an ethylene ethyl acrylate copolymer, any other polymer comprising at least 50% ethylene monomer, or a combination thereof.

11. The laminate of claim 1, wherein the BOPE film further comprises at least one of a high density polyethylene, a low density polyethylene, a linear low density polyethylene, a polyethylene plastomer, a polyethylene elastomer, an ethylene vinyl acetate copolymer, an ethylene ethyl acrylate copolymer, any other polymer comprising at least 50% ethylene monomer, or a combination thereof.

12. The laminate of claim 1, wherein the thickness of the BOPE film is from 10 to 70 microns.

13. The laminate of claim 1, wherein the thickness of the polyethylene film is from 20 to 200 microns, and wherein the polyethylene film comprises polyethylene having a melt index (I₂) from 0.5 to 6 g/10 minutes and a density from 0.900 to 0.960 g/cm³.

13. The laminate of claim 1, wherein the thickness ratio of the BOPE film to the polyethylene film is from 0.1 to 1.

14. An article formed from a laminate according to claim 1.
